(19) United States
(12) Patent Application Publication
(10) Pub. No.: US 2022/0261427 A1
(43) Pub. Date: Aug. 18, 2022

(54) METHODS AND SYSTEM FOR SEMANTIC SEARCH IN LARGE DATABASES

(71) Applicant: NEGENTROPICS MESTERSEGES INTELLIGENCIA KUTATO ES F, Budapest (HU)

(72) Inventors: Bela Lorant KOVACS, Debrecen (HU); Akos Jager, Budapest (HU)

(21) Appl. No.: 17/685,155

(22) Filed: Mar. 2, 2022

Related U.S. Application Data
(63) Continuation of application No. 15/729,296, filed on Oct. 10, 2017, now abandoned.

(51) Int. Cl. G06F 16/33; G06N 20/00; G06F 16/31; G06F 16/93; G06F 16/35; G06F 16/951; G06F 16/20; G06F 16/242

(52) U.S. Cl. CPC G06F 16/3344; G06N 20/00; G06F 16/31; G06F 16/93; G06F 16/243; G06F 16/951; G06F 16/20; G06F 16/35; G06F 16/353

(57) ABSTRACT

A computer-implemented method of performing a semantic search in a source document database containing documents that are identified by a unique document identifier, including: reading a text component of a text-containing query; generating a set of query features from the text component of the query using a predefined feature extraction model; generating a set of training features based on the plurality of query features; training a trainable classifier with the training features and a set of document features obtained from at least a portion of the source documents using a predefined feature extraction model; selecting a number of source documents for classification according to a predefined selection scheme; obtaining features of the selected documents; classifying the selected source documents into different classes of relevance by using features of the selected documents, where at least one value of relevance is associated with each selected document; ranking the classified documents in an ordered list based on their at least one associated value of relevance; and storing the ordered list of the identifiers of the ranked documents in a computer-readable memory.

### BACKGROUND

There is an increasingly growing demand for finding specific contents in electronic or paper-based documents, and due to the introduction of electronic document generation, storage and distribution or making such documents available for a limited or unlimited number of users, an ever-expanding amount of documents can be accessed in electronic form on the World Wide Web (“Web” or “Internet”) and other intranets. Document retrieval and search for a document with a specific content may be a rather time-consuming task, even if computers with appropriate search tools are used.

The document U.S. Pat. No. 7,249,121 discloses various methods and a system for the identification of semantic units from within a search query. A search engine for searching a corpus improves the relevancy of the results by classifying multiple terms in a search query as a single semantic unit. A semantic unit locator of the search engine generates a subset of documents that are generally relevant to the query based on the individual terms within the query. Combinations of search terms that define potential semantic units from the query are then evaluated against the subset of documents to determine which combinations of search terms should be classified as a semantic unit. The resultant semantic units are used to refine the results of the search. Although this solution provides a more accurate identification of compounds that correspond to a semantically meaningful text unit, it still has the drawback that the set of the relevant documents are determined in a straight-forward manner, i.e., based on comparison of various subsets of the query keywords or key text to the index of the corpus.

Current search engines fail to efficiently search large document databases. In many cases, due to the need to parse a large amount of text, document database searches are cumbersome, time-consuming, and make inefficient use of finite processor resources. In addition, many current search engines fail to rank results in a meaningful or dynamic order.

Due to the increased dispersion of digital data across multiple platforms and in multiple digital formats, there is a need in the art to provide semantic search techniques that make more efficient use of processor time and resources, and to further improve the relevance of the results set with respect to the text-based content searched by a querying entity. Through the improvement of the relevance of the results, a lower number of search queries are needed for a specific content search with respect to the conventional semantic search engines, which therefore reduces the bandwidth demand of the searches performed using the serving data communication network like the internet or an intranet.

Furthermore, due to a very compact representation of the source documents and the query texts, the memory and storage demands of the present semantic search engine solution are significantly lower than that of the known semantic search engines.

### TECHNICAL FIELD

The present disclosure relates generally to natural language processing, and more particularly, to search for contents in large document databases by using a semantic search engine.

### SUMMARY

Disclosed embodiments provide systems and methods for managing electronic transactions using electronic tokens and tokenized devices.

One aspect of the present disclosure is directed to a computer-implemented method of performing a semantic search in a source document database containing documents each being identified by a unique document identifier, the method including the following steps performed by a processing system: reading a text component of a text-containing query; generating a set of query features from the text component of the query using a predefined feature extraction model; generating a set of training features based on the plurality of query features; training a trainable classifier with the training features and a set of document features obtained from at least a portion of the source documents using a predefined feature extraction model; selecting a plurality of source documents for classification according to a predefined selection scheme; obtaining features of the selected documents; by the trained classifier, classifying the selected source documents into different classes of relevance by using features of the selected documents, wherein at least one value of relevance is associated with each selected document; ranking the classified documents in an ordered list based on the at least one associated value of relevance; and storing the ordered list of the identifiers of the ranked documents in a computer-readable memory.

Another aspect of the present disclosure is directed to a processing system for performing a semantic search in a document database, the system including at least one processor device including: a query interface configured to receive a text-containing query and to generate a text component from the text-containing query; a tokenizer component configured to generate a set of query features from the text-component of the query; a search engine component configured to produce an ordered list of identifiers of semantically relevant documents, the search engine including a classifier component configured to evaluate relevancy of a set of selected documents with respect to the text component of the query and a ranking component configured to produce an ordered list of identifiers of the classified documents based on the relevance of the classified documents; and a computer-readable memory for storing the ordered list of the identifiers of the relevant documents.

Another aspect of the present disclosure is directed to a computer-readable non-transitory medium having features relating to the above two aspects.

Another aspect of the present disclosure is directed to a system including one or more processor devices and one or more storage devices storing instructions that are operable, when executed by the one or more processor devices, to cause the one or more processor devices to perform the steps of the method according to the first aspect of the present disclosure.

Consistent with other disclosed embodiments, non-transitory computer readable storage media may store program instructions, which are executed by at least one processor device and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1A is a schematic block diagram illustrating the components of a pre-processing system configured to build databases for a semantic search to be performed by the processing system according to the present disclosure.

FIG. 1B is a schematic block diagram illustrating the basic components of the processing system according to the present disclosure.

FIG. 1C is a schematic block diagram illustrating the basic components and various optional components of the processing system according to the present disclosure.

FIG. 2 is a flow chart illustrating the major steps of the computer-implemented method of performing a semantic search in a database of text documents in accordance with the present disclosure.

FIG. 3 is a flow chart illustrating optional steps of the method according to the present disclosure.

FIG. 4 is a flow chart illustrating optional steps of the method according to the present disclosure.

FIG. 5 is a flow chart illustrating optional steps of the method according to the present disclosure.

FIG. 6 is a flow chart illustrating optional steps of the method according to the present disclosure.

FIG. 7 is a flow chart illustrating the steps of an embodiment of the search method according to the present disclosure.

FIG. 8 is a flow chart illustrating the steps of another embodiment of the search method according to the present disclosure.

FIG. 9 is a flow chart illustrating the steps of another embodiment of the search method according to the present disclosure.

### DETAILED DESCRIPTION

Reference The following detailed description of the disclosure refers to the accompanying drawings. The detailed description does not limit the invention. Instead, the scope of the invention is defined by the appended claims and equivalents.

As described herein, a tokenizer component extracts semantically characteristic features from a query text, a set of relevant documents may be selected using the characteristic features of the query text, a trainable classifier component may then be used to evaluate a selected set of source documents with respect to their relevance and the evaluated documents may be ordered in a list by their relevance.

As used herein, the term “characteristic feature” means a set of artificial binary codes representing the semantic content of a text, said codes being provided by applying an appropriate transformation operation to the binary representation of the text. The transformation from the binary representation of the text into the characteristic features may be carried out according to various modeling techniques as it will be described in more detail later.

Furthermore, the terms “content features,” “query features” and “training features” are used as a specific kind of characteristic features. In particular, content features are used to represent the content of the source documents, query features are used to represent the content of a query text and training features are characteristic features derived from the query features for using in the classification step of the method according to some embodiments.

Due to the use of the above mentioned characteristic features, the source documents and the query texts can be represented in a much more compact form with respect to the conventional solutions, which results in a significant reduction in the memory and storage requirements of the search engine.

Pre-Processing System for Building Search Databases

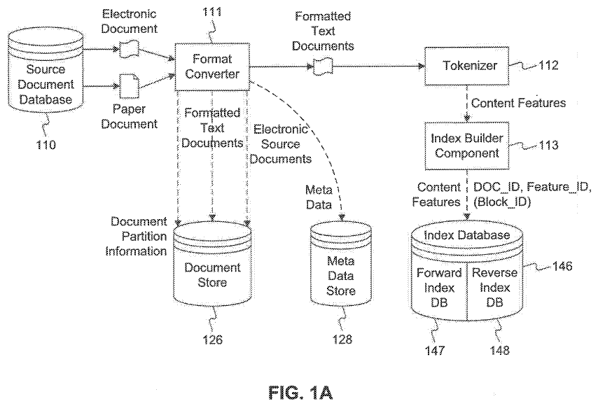

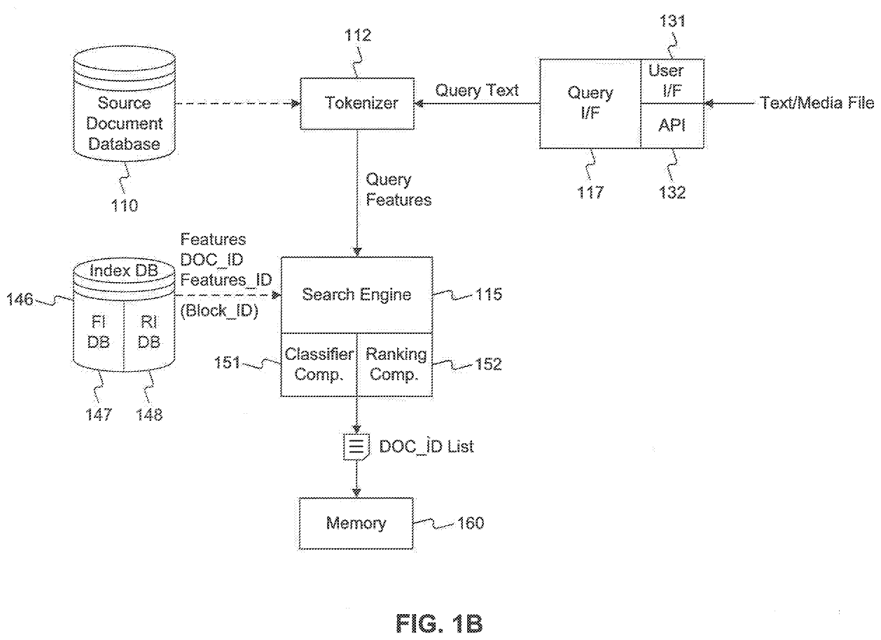

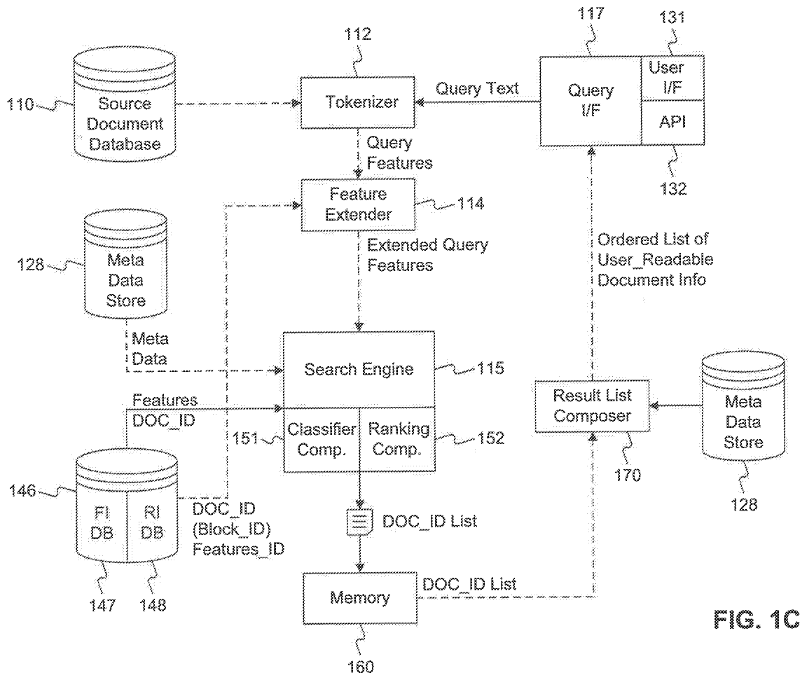

FIG. 1A is a schematic block diagram illustrating the components of a pre-processing system configured to build databases for a semantic search to be performed by a processing system according to the present disclosure, wherein the basic components are linked by solid-line arrows and optional components are linked by dashed-line arrows.

The pre-processing system depicted in FIG. 1A includes a format converter component 111 that may be configured to receive both paper documents and electronic documents from a source document data base 110, and may be configured to process the source documents to generate text documents in a predefined digital form, for example, in plain text format. These text documents will be herein referred to as formatted text documents. The format converter component 111 may include an optical scanner for digitizing paper documents, a text recognition program, such as optical character recognition (OCR), for generating an electronic document of a predefined text format from a scanned document, an audio text recognition application for generating an electronic document of a predefined text format from an audio file, and/or other appropriate hardware and software tools that may be used to generate formatted text documents from any type of paper or electronic source documents.

Within the context of the present disclosure, electronic documents may include any kind of text-containing media file, such as, for example, editable or non-editable text files, image files with text content, video files with displayed text content or audio text content, and/or audio files with audible text content. Paper documents may include, for example, any kind of printed or hand-written document that contains text information.

The formatted text documents generated by the format converter component 111 may be stored in a document store 126 for subsequent use. In a preferred embodiment, metadata, e.g., original file name, date of creation, author-related information, physical or access location, page number, document title, etc., may be produced and/or obtained from at least a subset of the source documents for the associated formatted text documents. These metadata may be stored in a metadata store 128.

The document store 126 may also be configured to store the formatted text documents. Storing the formatted text documents may have the advantage that these documents can be processed again, for example, for generating a new set of characteristic features therefrom by using a technique different from the one previously applied. In the bag-of-words model a characteristic feature may be defined as the likelihood of occurrence of a specific word in the analyzed text; in the n-gram model or the k-skip-n-gram model a characteristic feature may be defined as the likelihood of occurrence of various sets of words composed of ‘n’ words in the analyzed text, wherein the value of ‘n’ may be 2, 3 or even higher; and in vector space model, a characteristic feature may be defined as codes derived from one or more vectors of weights assigned to a word or a longer part of the analyzed text.

The formatted text documents generated by the format converter component 111 in a predefined form may be forwarded to a tokenizer 112 that is configured to generate a set of characteristic features from each of the digitized text documents provided by the format converter component 111. In some embodiments, the tokenizer 112 may also be configured to generate a set of characteristic features from a search text of a query during the search process, as will be described later. The tokenizer 112 may also be used to partition the formatted text documents into blocks, for example, into sentences, paragraphs, sections and/or other units, and to store partitioning information for the individual text blocks in the document store 126.

According to a preferred embodiment of the pre-processing system, the characteristic features of the digitized text documents may be forwarded from the tokenizer 112 to an index builder component 113 configured to be in operational relation with an index database 146. The index database 146 preferably includes two volumes, in particular a forward index database 147 and a reverse index database 148. In other embodiments the index database 146 may include a single volume or a plurality of volumes. The forward index database 147 may contain a plurality of lists of content features, wherein each feature list belongs to a specific document or a specific document part (e.g., text block). The reverse index database 148 may contain a plurality of lists of identifiers of documents or document parts (e.g., text blocks), wherein each document list or block list belongs to a specific content feature identified by a Feature_ID. In the index database, each of the documents may be identified by a unique identifier Doc_ID, each of the text blocks (when available) may be identified by a unique identifier Block_ID, and each of the content features may be identified by a unique identifier Feature_ID. The use and benefits of these databases will be described in detail below.

The index database 146 may be generated prior to the search by the index builder component 113, for example, before starting the operation of the processing system performing the semantic search. In the database generation phase, the index builder component 113 processes the content features of the documents and generates appropriate feature lists, document lists and/or block lists, all of which will be stored in the respective volume of the index data base 146. In some embodiments, in the database generation phase, the index builder component 113 may process the identified blocks of the documents.

The use of the index database 146 is beneficial since it may significantly increase the speed of the search process. Due to the use of the index database, a repeated pre-processing of the source documents at each search query action may be avoided and substantial computing power may be saved.

Processing System Performing Semantic Search

FIG. 1B depicts a schematic block diagram of the basic components of a processing system used to perform the semantic search in the source documents according to the present disclosure. The processing system may be integrated into a communication network, through which the search functions of the processing system can be accessed from other processing systems or devices. The communication network may be the Internet, a corporate intranet, or any other appropriate communication network that interacts with application programs running on processor devices, such as computers, laptops, tablets, smart phones, PDAs, etc.

The processing system may include a query interface 117 configured to receive a text of variable length as a search text (also referred to as a query text) and to forward the text to the above mentioned tokenizer 112. The query interface 117 may receive the search text from a querying entity either directly from a user through a user interface 131 or from a retrieving computer program through an application programming interface (API) 132. The user interface 131 may be configured to allow a user to enter at least a search query in text format, and it may be further configured to provide other optional functions to facilitate the use of the search tool, to make the presentation of the search results more effectively, to allow customization of the user interface, etc. In a preferred embodiment, the user interface 131 may be configured to allow a user to specify a text-containing media file, for example, a text containing audio file, image file, and/or video file, from which the query text may be extracted in the same way as it is done in the pre-processing phase.

The query text directly received by the query interface 117 or generated from an input text-containing media file may be forwarded to the tokenizer 112 that generates a set of characteristic features from the query text using the source document database 110. In some embodiments, the set of characteristic features may be generated from the query text using the index database 146 built in the pre-processing phase.

The characteristic features obtained from the query text (i.e., the query features) may then be forwarded to a search engine 115. The characteristic features may include a classifier component 151 for evaluating relevancy of a plurality of selected documents with respect to a search term and a ranking component 152 used for ranking the selected documents by their relevance (e.g., by using scores of relevance generated by the classifier component). In some embodiments, the search engine 115 may be coupled to an index database 146 from which the search engine 115 retrieves at least document identifiers and content features for the classification process.

“Relevance” in this context may be defined based on factors including, but not limited to, content-similarity or other kind of close semantic relation between the content of the query text and/or the content of the returned documents.

As shown in FIG. 1C, in some embodiments, the search engine 115 may be coupled to the metadata store 128 when the metadata of the classified documents is intended to be used to improve the ranking quality of the documents or to generate a document result list with user-readable information about the returned documents (e.g., URL of an electronic document, publisher of a paper document, document title, etc.).

The search engine 115 may also receive additional characteristic features from a feature extender component 114 that generates an extended set of characteristic features using the characteristic features provided by the tokenizer 112, as illustrated in FIG. 1C. In some embodiments, the feature extender component 114 may be coupled to the index database 146.

The search engine 115 may output an ordered list of document identifiers. In some embodiments, the search engine 115 may output an ordered list of block identifiers of relevant documents including identification of their incorporating documents. The returned result list may then be stored in a memory 160 as shown in FIGS. 1B and 1C. The result list may also be forwarded to a result list composer 170, which produces the above mentioned processed, user-readable list of the returned relevant documents or document parts (e.g., bibliographic data, URL, etc.) using the document identifiers and/or block identifiers and the metadata stored for the ranked documents in the metadata store, thereby allowing the user or the querying computer program to access or download any one of the ranked documents on demand. This processed list of documents may then be forwarded to the query interface 117, as shown in FIG. 1C, which in turn, may output the processed list through the user interface 131 to the querying user or through the API 132 to the querying computer program. The user interface 131 may also display the processed list to the user on a display device.

While the processing system according to the present disclosure was described as an integrated computing platform that includes a number of hardware components, such as a processor, databases or a memory, and a number of software components, such a search engine, an interface component, etc., a skilled artisan will recognize that the various hardware or software components may be implemented in more than one co-operating processing devices and/or by more than one cooperating software components, which together provide all of the above mentioned essential functions of the processing system according to the disclosure. Those skilled the art will further recognize that any one of the hardware or software components of the processing system may be multiplied and operated in parallel in order to achieve a faster operation of the search tool.

Search Process

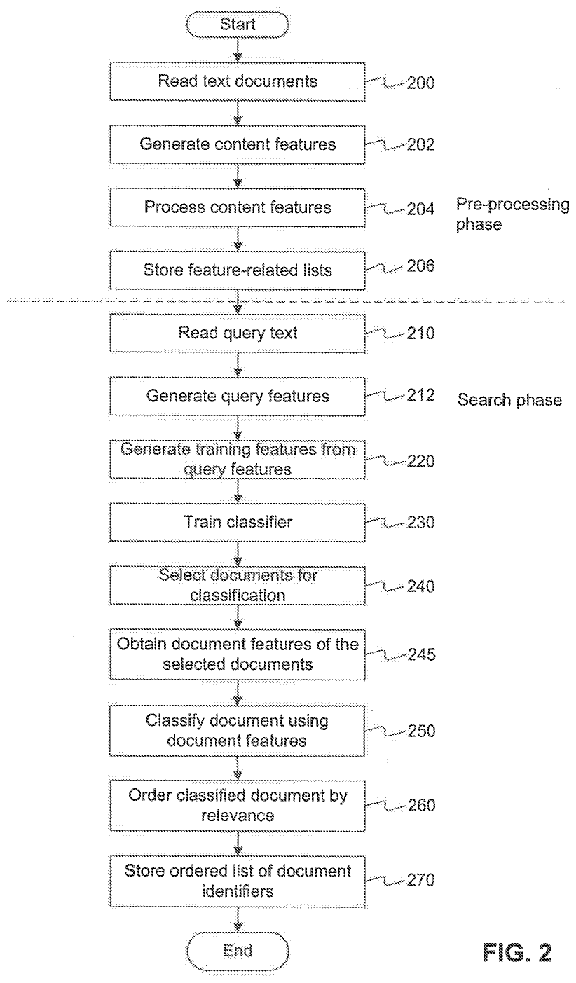

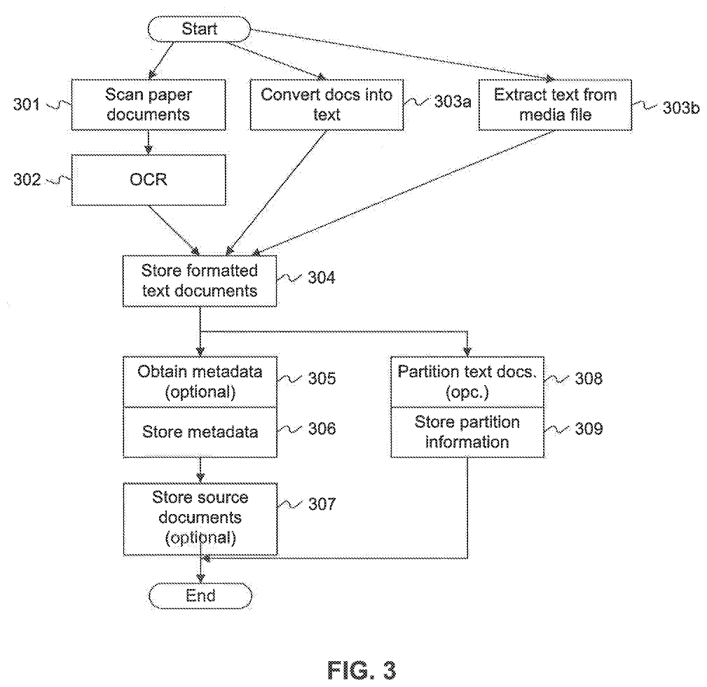

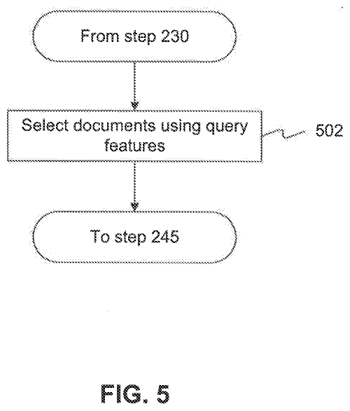

The operation of the semantic search tool according to some embodiments will now be described with reference to FIGS. 2 through 6, wherein FIG. 2 is a flow diagram of the basic steps of the method of semantic search according to the present disclosure and FIGS. 3 to 6 are flow diagrams illustrating various optional steps of the method of the present disclosure.

Building Document Store and Meta Data Store

In some embodiments, the operation of the search tool assumes the existence of at least a document store containing a plurality of formatted text documents among which relevant documents may be sought using a search query. The document store may be built using a source document database, for example, a corporate document store, a content-specific private or public database and/or any other database containing any type of documents with restricted or unrestricted access through a communication network, like the Internet. In some embodiments, the source document database may be a predefined set of electronic documents freely accessible via the Internet.

In some embodiments, building the document store (i.e., obtaining and pre-processing source documents, and uploading the formatted text documents into the document store) may be a separate, optional step for establishing a search environment. The steps of a preferred embodiment of establishing the search environment is illustrated in the flow chart of FIG. 3.

As shown in FIG. 3, first a plurality of source documents, e.g., printed and/or hand-written paper documents and electronic documents, are converted into formatted text documents of a predefined format (e.g., plain text). The electronic source documents may include editable or non-editable text documents, image documents, combined text-image documents, text-containing audio, image or video files, etc. In some embodiments, paper documents may be digitized by an optical scanner in step 301, and then the text parts of the scanned documents may be subject to optical character recognition (OCR) in step 302 to generate text documents. The image objects within the paper documents may be scanned as images and may be incorporated in the digitized text documents as image objects, or a text reference to the image objects may be inserted into the text of the scanned paper documents in place of the images. Similarly, an electronic document may be digitally converted into a formatted text document in step 303a with the option of either keeping the original image objects within the text or inserting a text reference into the text in place thereof. If a text-containing media file is input as a query, the text component of the media file may be extracted in step 303b and converted into a text document of predefined format.

The formatted text documents may then be stored, in step 304, in the document store with a unique document identifier Doc_ID. If the formatted text documents are partitioned into text blocks by the tokenizer in step 308, each of the individual text blocks of the formatted text documents may be identified by a unique block identifier Block_ID, and these identifiers along with any other partition information may also be stored in the document store in step 309. The partition information may include an assignment relation between a source document and the identified text blocks of the given document. In some embodiments, all of the blocks of a source document are provided with a unique identifier. In other embodiments, only the blocks that presumably contain useful information for meaningful semantic searches are uniquely identified. For example, in some embodiments, content tables, figure lists, publishing details, etc., may form separate text blocks that are unnecessary to be uniquely identified.

In some embodiments, obtaining metadata from the source documents, in step 305, is an optional step of the pre-processing phase. Metadata may be extracted from the source documents and/or metadata may be generated from physical or other properties of the paper-based and/or electronic source documents. The metadata may include, for example, original document name (e.g., file name), date of production or last modification, author of the document, physical or URL location of the document, page number, original document/file format, document title, etc. Once metadata is obtained, the metadata is uploaded into the metadata store and may be used for preparing the result list and for fine-tuning the ranking algorithm run by the search engine.

The metadata store may be built along with the generation of the document store. The metadata of the source documents may be stored, in step 306, in the metadata store with references to the associated formatted text documents identified by the parameter Doc_ID.

As mention above, in a preferred embodiment, the source documents may be stored in digital form in the document store, in step 307.

Extracting Characteristic Features from the Source Documents

The semantic search may be based on the use of specific semantic information gained from the source documents (in the pre-processing phase) and on the text of the search query (in the search phase). The semantic information may be represented by a set of characteristic features. The characteristic features of the source documents or document parts are referred to as content features, whereas the characteristic features of a search query text are referred to as query features.

The characteristic features may be generated from the formatted text documents (cf., content features) and the text queries (cf., query features) by the tokenizer.

First, as shown in the flow chart of FIG. 2, the formatted text documents may be read by the tokenizer in step 200. Then, the content features of these documents may be generated in step 202 by the tokenizer. In a preferred embodiment of the search method, the generated content features are processed in step 204 by the index building component which produces the above mentioned document feature lists, block feature lists, and/or the block lists. These lists may then be stored in the index database in step 206. The foregoing steps 200 to 206 may be performed within the pre-processing phase.

The characteristic features of the source documents (i.e., the content features) may be obtained from the analyzed text of the associated formatted text documents by a processing algorithm and may be represented in binary form as binary vectors or binary matrices (two or more dimensional matrices). The content features may be represented, for example, according to the bag-of-words model, the n-gram model, k-skip-n-gram model or the vector space model, which are well known semantic modelling techniques of text documents.

For example, in the bag-of-words model a characteristic feature may be defined as the likelihood of occurrence of a specific word in the analyzed text; in the n-gram model or the k-skip-n-gram model a characteristic feature may be defined as the likelihood of occurrence of various sets of words composed of ‘n’ words in the analyzed text, wherein the value of ‘n’ may be 2, 3 or even higher; and in vector space model, a characteristic feature may be defined as codes derived from one or more vectors of weights assigned to a word or a longer part of the analyzed text.

When the limitation of the number of the content features is a consideration, various know techniques may be used for reducing the number of characteristic features of a text. These limitation techniques include, among others, the stop word filtering method, the term frequency-inverse document frequency (tf-idf) method, which eliminates the irrelevant characteristic features, or the chi-square method, which can be used to select the characteristic features of higher relevancy from the entire list of characteristic features generated for a given text.

Building the Index Database

Once the tokenizer has read a formatted text document and generated the content features for the associated source document, the list of the content features associated with the particular document (the so-called document features) may be forwarded to the index builder component which processes these features into various lists in step 204, as mentioned above. The index builder component stores the document feature list in the index database in step 206, in particular in its forward index database. In some embodiments, when the formatted text documents are partitioned into blocks by the tokenizer, the index builder component may also store a list of the content features, also referred to as a block feature list, for each of the identified blocks (the so-called block features) in the forward index database of the index database in step 206.

In step 204 the index builder component may also generate a reverse index database from the document feature lists stored in the forward index database. The reverse index database may include a plurality of document lists, each element of the document list containing the identifiers of those documents that are associated with a particular document feature. The reverse document lists may be stored in the reverse index database of the index database by the index builder component in step 206.

The index builder component may additionally generate a plurality of block lists, each element of this list containing the identifiers of those (previously identified) blocks that are associated with a particular block feature. The block lists, when available, may also be stored in the reverse index database of the index database by the index builder component in step 206.

In some embodiments, the above step of index building may be omitted. However, building an index database may significantly increase the speed of the search process, particularly in a semantic search in a large document database. In the absence of the index building step, and consequently without using the index database, the search process may still be carried out, but depending on the search methodology, a single reading or repeated reading of the whole source database at each search will be needed for obtaining those document features which are necessary to determine the set of documents to be classified.

Extracting Characteristic Features from the Query Text

The characteristic features of the query text (i.e., the query features) may be gained from the query text in the same way as mentioned above in connection with the content features of the source documents. The query features may be represented, for example, according to the bag-of-words model, the n-gram model or the vector space model, which are well known semantic modelling techniques of texts. In some embodiments, the semantic representations of the characteristic features may be used for simple query words. In some embodiments, the semantic representations of the characteristic features may be beneficial in longer query texts.

In some embodiments, in order to keep the number and the size of the above mentioned binary characteristic features of the search queries within reasonable ranges, the allowed length of the text of the search query may be limited to a predetermined size.

Once the document store and the index database, including the forward index database, the reverse index database, and/or the metadata store, have been built based on the source documents, the search tool may carry out a semantic search using an input text query. The steps of the search phase are also depicted in FIG. 2.

In step 210, after prompting the user or after a retrieving computer program provides a text or text-containing media file, for which semantic search is required among the source documents, the query text may be read or generated by the query interface, depending on the type of the query input, and forwarded to the tokenizer, which in turn, may generate a set of characteristic features, i.e., the query features, for the query text in step 212.

In one embodiment, the query text includes individual words (e.g., “mobile,” “phone,” “price”) or specific meta data (e.g., “Jason Smith,” “Oxford Press”), wherein the words are used for full-text searches. In some embodiments, metadata is used to search for documents based on of pre-assigned attributes of the source documents. The query words may be obtained from the metadata of the documents and may be generated on a statistical basis or may be extracted from the content of the source documents by any known text analyzing technique. In some embodiments, the query words may be specified at a search query and defined by the users.

The query text may also be represented in the form of coherent sets of words, called a query phrase, when the input words are in a semantic relation with each other in a specific context (e.g., “mobile phone applications for XY operating system”).

In one embodiment, the query text may be a text part of an available document and may be copied from the document in a predefined text format (e.g., in plain text format) and then pasted into a query window of the user interface.

In some embodiments, the query input may be a complete media file or a part of a media file that contains displayed or audible text information.

In some embodiments, the meaningful text is a certain part (e.g., one or more paragraphs) of a document or recognizable text information within an audio, image or video file, for which other documents with similar content are sought in the source document database. The meaningful text may also be a substantially coherent text uniquely entered by the user through the user interface.

Generating Training Features for Training the Classifier

After the query features have been generated by the tokenizer, the query features may be forwarded to the search engine. The classifier component may first be prepared for training with a training feature set by generating, in step 220, the training features using the query feature set. The training feature set may be generated by the search engine according to various schemes as described below.

In a first exemplary scheme, the training feature set is defined to be identical with the previously obtained set of query features.

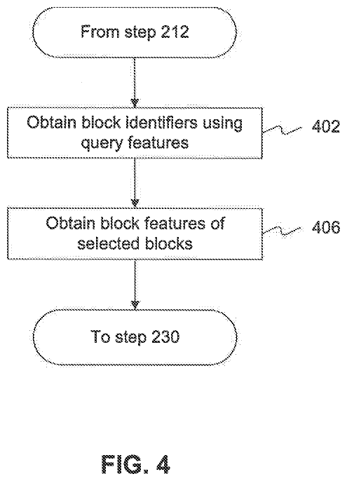

In another exemplary scheme, which presumes a preceding process of partitioning the formatted text documents into blocks, the number of query features should be increased for queries resulting in a rather low number of query features, e.g., when specifying only some words or short query phrases for the search. This exemplary scheme may include the following steps, as shown in FIG. 4, performed by the search engine: obtaining the identifiers Block_ID of all blocks that are associated with at least one of the query features, in step 402; and obtaining features associated with each of the selected blocks in step 406.

When the search tool uses an index database having a forward index database and a reverse index database for making the search faster, the block identifiers may be retrieved from the reverse index database in the above step 402, and the block features may be retrieved from the forward index database in the above step 406. However, in absence of the index database, the required block identifiers and block features may be obtained by reading and processing the entire document database during the search.

The resulting set of the features associated with the selected blocks may then be defined to be the training feature set. In some embodiments, the extended set of training features may also include the query features, thereby adding features (i.e., further paragraph features) to the existing query features, where the additional features may be in close semantic relation with the existing query features.

In some embodiments, a list returned by retrieval from the forward or reverse index database may include any identifier or feature in a single instance, even if multiple lists are returned with one or more common elements.

Training the Classifier

The classifier component of the search engine may be trained at every query, in step 230, using the training feature set. The classifier component may have at least two output classes that correspond to different levels of relevancy of the source documents, the features of which are presented to the classifier component in ranking the documents. In a preferred embodiment, the classifier component has exactly two classes, the first class corresponding to relevant features and the second class corresponding to non-relevant features. In other embodiments, the classifier component has one class. In other embodiments, the classifier component has more than two classes. The training procedure will be described below assuming that the classifier component has two classes of relevance, namely a first class and a second class. However, a skilled person can extrapolate these techniques to perform the training of other classifiers with more than two classes of relevancy.

In some embodiments, the training procedure includes two phases. In the first phase, the classifier component may be trained to learn relevant features. The training feature set, previously generated from the query features, may be presented to the classifier component specifying the first class to which the training features belong.

In the second phase, the classifier component may be trained to learn non-relevant features by presenting a plurality of document features to the classifier component specifying the second class to which the non-relevant features belong. The presented set of document features may include all different document features stored in the index database, or the set of document features may include only a predefined sub-set of the document features stored in the index database. For example, the set of document features used in the second phase of training may include all document features of the index database except the document features of the training feature set used in the first phase of the training.

The above mentioned two phases of training the classifier component may be carried out in any order or even in parallel, depending on the type of the classifier used by the search engine.

Selecting Documents for Classification

Once the classifier component has been trained with the training features generated based on the query features and a set of document features selected from the index database, the search engine may classify any number of documents in the document store. For the classification, a set of formatted text documents may be selected from the document store in step 240. In the classification process, the classifier component evaluates the document features of the selected documents to generate a relevance value for each selected document with respect to their belonging to each class of relevancy. The set of documents to be classified may be selected in various ways.

In a first exemplary approach, all of the source documents are classified. The classification of all source documents may be excessively time-consuming in a large document store with millions of documents. However, the classification of all of source documents would result in the most accurate search.

In another exemplary approach, a reduced set of the source documents are classified, which allows a faster classification. The documents may be selected for classification by various schemes, from which two schemes are introduced hereinafter as examples.

In one embodiment of a selection scheme, documents are selected that contain at least one of the training features. In a preferred embodiment, the documents selected contain the most possible training features. The training features may include i) the query features themselves (e.g., when a substantial number of features can be obtained for training the classifier component), and/or ii) an extended set of the query features (e.g., when there are not enough features obtained from the query text for training the classifier component). This embodiment of the selection scheme, in which the selected documents are in a close semantic relation with each other, includes obtaining the identifiers Doc_ID of the documents that are associated with at least one of the query features, in step 502.

In a preferred embodiment of the search method, in the above step 502, the identifiers of only those documents are obtained that are individually associated with the most possible query features. Alternatively, those documents may also be selected that are associated with all of the query features, however this approach yields a rather limited set of source documents thereby increasing the speed of the search, but may deteriorate the search accuracy.

When the search tool uses an index database having a forward index database and a reverse index database for making the search faster, the document identifiers may be retrieved from the reverse index database in the above step 502. However, in absence of the index database, the required document identifiers can be obtained only by reading and processing the entire source document database during the search.

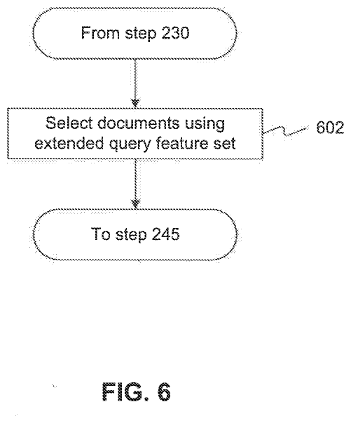

In another embodiment of a selection scheme, the documents selected for classification contain at least one feature, but preferably the most possible features of extended set of query features. This embodiment of the selection scheme produces a larger set of documents than the selection method described above, and thereby the selected documents cover a semantically broader domain. The following step of the second selection scheme, as shown in FIG. 6, may be carried out by the search engine obtaining the identifiers Doc_ID of the documents that are associated with at least one of the features of an extended set of query features, in step 602.

When the search tool uses an index database having a forward index database and a reverse index database for making the search faster, the document identifiers and the block identifiers may be retrieved from the reverse index database in the above steps 602 and 610, respectively, while the block features may be retrieved from the forward index database in the above step 606. However, in absence of the index database, the required identifiers and features can be obtained only by reading and processing the entire source document database during the search.

As mentioned above, in the following step of classification, all documents or preferably, only a reduced number of documents are selected for relevancy evaluation.

Classifying the Documents

When classifying the documents, all of the document features of each previously selected document may be presented to the classifier component to evaluate the given document with regard to its relevance. To this end, the document features of the selected documents may be obtained by reading all of the documents from the source document database or preferably, the document features of the source documents may be retrieved from the forward index database in step 245. Then in step 250, the thus obtained document features are presented to the previously trained classifier component for evaluating the documents.

As a result of the classification, the classifier component outputs one or more relevance values, e.g., scores, probabilities, logical values, etc., for each classified document, wherein the at least one relevance value assigned to a particular document represents the extent of the document's belonging to the different classes of relevance. For example, when two classes of relevance are defined in the classifier component (i.e., a first class for the semantically relevant documents and a second class for the semantically non-relevant documents), the documents will be classified into both classes to a specific extent. It means that when, for a particular document, the relevance value of the first class is defined a higher relevance than the relevance value of the second class, the given document is regarded to be relevant with respect to the query text, otherwise it is regarded non-relevant. The relevance value(s) produced by the classifier component may be represented in the form of integers, floating point values (e.g., score values), logical values (e.g., true and false), or a vector or a matrix thereof, wherein the type and range of the relevance values depend on the type of the classifier used in the search engine.

Within the classifier component the following types of trainable classifiers may be used among others: Naive Bayes classifier, Support Vector Machine (SVM) classifier, Multinomial Logistic Regression classifier, Hidden Markov model classifier, Neural network classifier, k-Nearest Neighbors classifier, or the like.

The representation of the source documents and the query texts by characteristic features (i.e., content features and query features, respectively) allows a very efficient classification of the selected source documents since there is no need of analyzing the whole text of the selected documents on a word-basis as done in the conventional semantic search engines, but only the characteristic features thereof are used for the content analysis. In some embodiments, this property makes the search faster and significantly reduces the memory demands thereof. Furthermore, the source documents are not needed to be permanently stored for the purpose of classification (as needed in the conventional semantic search engines) and therefore substantial storage capacity can also be saved.

Ranking the Classified Documents

After the classifier component finished classification of the selected documents, the classified documents may be ordered by relevance using the ranking component of the search engine in step 260. For ordering the documents by relevance, various schemes may be used depending on the type of the specific search tool.

In one exemplary scheme, the relevance value of each class is taken into account for the documents to be ranked. With each classified document, the values of the associated different relevance classes may be weighted according to a predetermined algorithm to produce an ordered list of the semantically relevant documents.

In a preferred exemplary scheme, the relevance values belonging to only one of the relevance classes are used to rank the documents. For example, when two classes of relevance are defined, only the relevance values of the class defining high relevance are taken into account by the ranking component.

The final result of the search process is therefore an ordered list of document identifiers that specify the classified source documents ordered by their relevance with respect to the search query. This list may be stored in a computer-readable memory in step 270.

The ordered list of the identifiers of the relevant documents may be further processed by the result list composer component to generate a list of the documents in a format that can be interpreted by the querying user or the querying computer program. A processed document list may be generated by means of the result list composer component using the documents identifiers (or the block identifiers) and the metadata stored in the metadata store. The processed list may contain access information and other useful information about the returned documents or document parts, for example specific bibliographic data, URL of the electronic documents, document title, etc.). Due to this processed list, the querying user or the querying computer program may access or download any one or more of the ranked documents on demand. This processed list of documents may be forwarded to the query interface, which in turn forwards the list to the user through the user interface or to querying computer program through the API.

In some embodiments, the ranking component may also use the metadata of the documents, when available, for providing a more accurate ranking of the relevant documents in terms of semantics. For example, the name of the author of the documents, or the field of science or technology obtained from the metadata of the documents may further increase (or even decrease) their relevance in view of the content of the query text.

### Examples

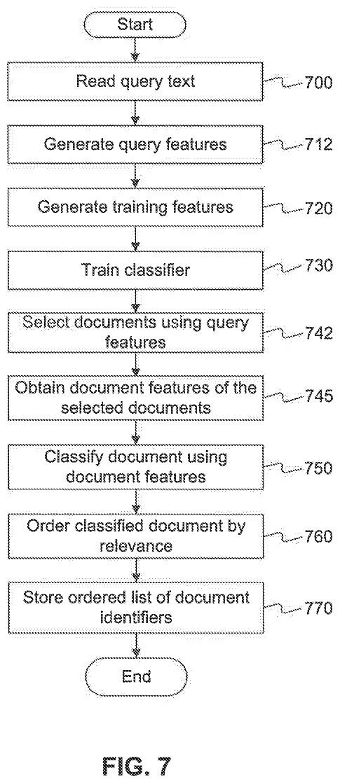

In a first example, the steps of a so-called similarity search are described with reference to FIG. 7. The search is optimized for semantic searches based on longer coherent texts (e.g., selected parts of conference papers, books, official documents, etc.).

As a first step of this exemplary search, a query text is received from the query interface in step 700. Then in step 712, the query features are generated from the query text by a predetermined scheme or model built in the tokenizer. The query features are defined to be the training features in step 720 and the classifier component is trained with these features in step 730.

For the classification, the documents containing at least one of the query features, but preferably the most possible query features, are selected for classification. First the identifiers Doc_ID of these documents are obtained in step 742, for example by retrieving the document identifiers from the reverse index database of the index database when the index database is available. In this example, step 742 corresponds to the above optional step 502. The document features of the selected documents are obtained in step 745, for example by retrieving them from the forward index database.

The previously trained classifier component is used, in step 750, to classify the selected documents by relevance using their document features. The classified documents are then ordered in step 760 based on the relevance values produced by the classifier component using a predetermined ranking algorithm, optionally taking the metadata associated with the classified documents also into view. The list of the identifiers of the ordered relevant documents is stored in a computer-readable memory in step 770.

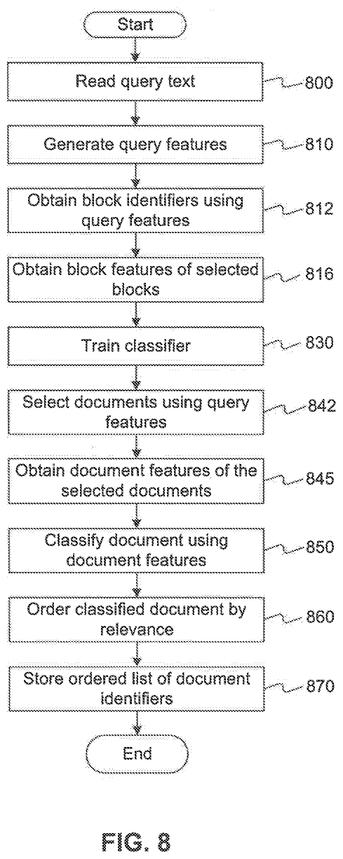

In a second example, the steps of a so-called keyword search are described with reference to FIG. 8. This search is optimized for semantic searches based on a limited number of keywords, typically a few words guessed by a user, when only a restricted portion of the source document database is intended to be sought.

In a first step, the keywords of the query are received from the query interface in step 800. Next, the query features are generated from the specific keywords in step 810. The resulted query features can be the keywords themselves (without using any transformation), or the query features may be gained from the keywords by using any one of the above mentioned predetermined scheme or model. Since in this example, the number of the query features is not likely to be enough for an appropriate training of the classifier component, extension of the set of the query features is to be carried out to generate an extended set of query features which will be used as a training feature set. Steps 812 and 816 of the feature extension correspond to the steps 402 and 406 described above with reference to FIG. 4. Accordingly, first the identifiers Block_ID of the blocks that are associated with at least one of the query features are obtained in step 812, and then all block features associated with each of the selected blocks are obtained in step 816. This set of block features associated with the selected blocks is defined as an extended set of query features and used as a training feature set.

In this example again, when an index database is available, the block identifiers of the selected blocks may be obtained in step 812 by retrieving the block identifiers from the reverse index database, and the block features may be obtained in step 816 by retrieving the block features from the forward index database.

The classifier component is then trained with the extended training features in step 830.

For the classification, the documents containing at least one of the query features, but preferably the most possible query features are selected in step 842. Optionally, the documents containing at least one of the features of an extended set of query features may be selected, resulting in an even larger selection domain of the source documents. The document selection can be done by retrieving the identifiers Doc_ID of the appropriate documents from the reverse index database of the index database when an index database is available. The document features of the selected documents are then obtained in step 845 for training the classifier. The document features may, for example, be retrieved from the forward index database when an index database is available.

The previously trained classifier component is used, in step 850, to classify the selected documents by relevance using their document features. The classified documents are then ordered in step 860 based on the relevance values produced by the classifier component using a predetermined ranking algorithm, optionally taking the metadata associated with the classified documents also into view. The list of the identifiers of the ordered relevant documents is stored in a computer-readable memory in step 870.

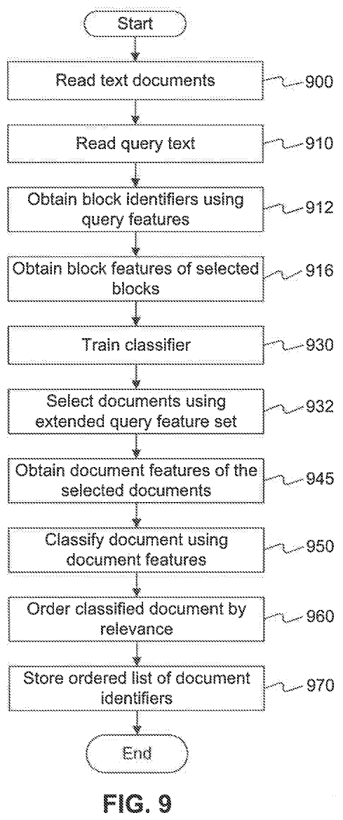

In a third example, the steps of a so-called associative search are described with reference to FIG. 9. This search is optimized for semantic searches based on a limited number of keywords, typically a few words guessed by a user, when a larger portion of the source document database is intended to be sought.

In a first step, a query text is received from the query interface in step 900. Then in step 910, the query features are generated from the received query words. The query features may be the words themselves of the input text (without using any transformation), or the query features may be gained from the query text by using any one of the above mentioned predetermined scheme or model. Since in this example again, the number of the query features is not likely to be enough for an appropriate training of the classifier component, extension of the set of the query features is to be carried out to generate an extended set of query features defined as a training feature set. The steps 912 and 916 of this method therefore correspond to the steps 402 and 406, respectively, described above with reference to FIG. 4. Accordingly, first the identifiers Block_ID of all blocks that are associated with at least one of the query features are obtained in step 912, for example by retrieving them from the reverse index database of the index database when an index database is available. Thus a list of selected blocks is produced. Next all block features associated with each of the selected blocks are obtained in step 916, for example by retrieving the block features from the forward index database of the index database when an index database is available. The set of the block features associated with the selected blocks is defined as an extended training feature set and will be used as a training feature set.

The classifier component is then trained with the extended training features in step 930.

For the classification, either all of the source documents or a reduced set of the source documents are selected from the source document database. In the latter case, the documents to be classified are selected in step 932, which corresponds to step 602 described above with reference to FIG. 6.

When having a set of documents selected for classification, the document features of the selected documents are obtained in step 945, for example by retrieving them from the forward index database when an index database is available.

The classification is carried out using the documents selected in steps 932 to 942. The previously trained classifier component is used, in step 950, to classify the selected documents by relevance with using their document features as input. The classified documents are then ordered in step 960 based on the relevance values produced by the classifier component using a predetermined ranking algorithm, optionally taking the metadata associated with the classified documents also into view. The list of the identifiers of the ordered relevant documents is stored in a computer-readable memory in step 970.

The systems and methods described herein provide semantic search techniques that make more efficient use of processor time and resources, and further improve the relevance of the results set with respect to the text-based content searched by a querying entity. In some embodiments, the semantic search techniques improve upon prior art semantic search engines by employing an advanced technique of classification of the documents using a bidirectional indexing of the documents. Due to these improvements the search engine of the present invention significantly reduces the bandwidth demand of the searches through the serving communication network like the internet or an intranet and also reduces the storage and memory demands of the search engine. Embodiments of the semantic search engine are particularly beneficial for full text searches.

The foregoing description of preferred embodiments of the present invention provides illustration and description, but is not intended to be exhaustive or to limit the invention to the precise form disclosed, Modifications and variations are possible in light of the above teachings or may be acquired from practice of the disclosure. In particular, while exemplary methods of the present invention are described as a series of acts, the order of the acts may vary in other implementations consistent with the present invention. In particular, non-dependent acts may be performed in any order or in parallel.

The scope of the invention is defined by the claims and their equivalents.

What is claimed is:

1. A computer-implemented method of performing a semantic search in a source document database containing documents each being identified by a unique document identifier, the method comprising:
reading a text component of a text-containing query;
generating a set of query features from the text component of the query using a predefined feature extraction model;
generating a set of training features based on the plurality of query features;
training a trainable classifier with the training features and a set of document features obtained from at least a portion of the source documents using a predefined feature extraction model;
selecting a plurality of source documents for classification according to a predefined selection scheme;
obtaining features of the selected documents;
by the trained classifier, classifying the selected source documents into different classes of relevance by using features of the selected documents, wherein at least one value of relevance is associated with each selected document;
ranking the classified documents in an ordered list based on the at least one value of relevance; and
storing the ordered list of the identifiers of the ranked documents in a computer-readable memory.

2. The method of claim 1, wherein the query entity includes at least one of a user interface and an application programming interface.

3. The method of claim 1, further comprising:
defining the training features to be identical with the query features.

4. The method of claim 1, further comprising, prior to the classification:
partitioning at least a portion of the documents stored in the source document database into blocks, each block being uniquely identified by a block identifier; and
generating a plurality of block features for each block.

5. The method of claim 4, wherein selecting documents for classification comprises:
obtaining the identifier of the source documents that are associated with at least one of the features of an extended set of query features.

6. The method of claim 1 wherein generating a training feature set comprises:
obtaining the identifier of the blocks that are associated with at least one of the query features;
obtaining block features associated with each of the previously selected blocks, thereby producing an extended set of query features; and
defining the extended set of query features to be the training feature set.

7. The method of claim 1, wherein selecting documents for classification comprises:
selecting all documents stored in the source document database.

8. The method of claim 1, wherein selecting documents for classification comprises:
obtaining the identifier of the source documents that are associated with at least one of the query features.

9. The method of claim 1, wherein the text-containing query comprises any one of a printed paper document, a hand-written paper document, an editable or non-editable electronic text document, an image file with text content, a video file with displayed text content or audio text content, or an audio file with audible text content.

10. The method of claim 1, wherein the feature extraction model is one of a bag-of-words model, a continuous bag-of-words model, a continuous space language model, an n-gram model, a skip-gram model, and a vector space model.

11. The method of claim 1, wherein the trainable classifier is one of a Naive Bayes classifier, a Support Vector Machine (SVM) classifier, a Multinomial Logistic Regression classifier, a Hidden Markov model classifier, a Neural network classifier, a k-Nearest Neighbours classifier, and a Maximum Entropy classifier.

12. A processing system for performing a semantic search in a document database, the system comprising:
at least one processor device comprising:
a query interface configured to receive a text-containing query and to generate a text component from the text-containing query;
a tokenizer component configured to generate a set of query features from the text-component of the query;
a search engine component configured to produce an ordered list of identifiers of semantically relevant documents, the search engine comprising:
a classifier component configured to evaluate relevancy of a set of selected documents with respect to the text component of the query, and
a ranking component configured to produce an ordered list of identifiers of the classified documents based on the relevance of the classified documents; and
a computer-readable memory for storing the ordered list of the identifiers of the relevant documents.

13. The processing system of claim 12, further comprising a metadata store configured to store a plurality of metadata associated with the source documents.

14. The processing system of claim 12, further comprising a feature extender component configured to generate an extended set of query features using the query features provided by the tokenizer.

15. A computer-readable non-transitory medium storing instructions for causing at least one processor device to perform a method for a semantic search in a source document database, the method comprising:
reading a text component of a text-containing query;
generating a set of query features from the text component of the query using a predefined feature extraction model;
generating a set of training features based on the plurality of query features;
training a trainable classifier with the training features and a set of document features obtained from at least a portion of the source documents using a predefined feature extraction model;
selecting a plurality of source documents for classification according to a predefined selection scheme;
obtaining features of the selected documents;
by the trained classifier, classifying the selected source documents into different classes of relevance by using document features of the selected documents, wherein at least one value of relevance is associated with each selected document;
ranking the classified documents in an ordered list based on their at least one associated value of relevance; and
storing the ordered list of the identifiers of the ranked documents in a computer-readable memory.

16. The computer-readable medium of claim 15, wherein the query entity includes at least one of a user interface and an application programming interface.

17. The computer-readable medium of claim 15, wherein the training features are defined to be identical with the query features.

18. The computer-readable medium of claim 15, wherein prior to the classification:
partitioning at least a portion of the documents stored in the source document database into blocks, each block being uniquely identified by a block identifier; and
generating a plurality of block features for each block.

19. The computer readable medium of claim 15 wherein generating a training feature set comprises:
obtaining the identifier of the blocks that are associated with at least one of the query features;
obtaining block features associated with each of the previously selected blocks, thereby producing an extended set of query features; and
defining the extended set of query features to be the training feature set.

20. The computer-readable medium of claim 18, wherein selecting the documents for classification comprises:
obtaining the identifier of the source documents that are associated with at least one of the features of an extended set of query features.

21. The computer-readable medium of claim 15, wherein selecting the documents for classification comprises selecting all documents stored in the source document database.

22. The computer-readable medium of claim 15, wherein selecting the documents for classification comprises:
obtaining the identifier of the source documents that are associated with at least one of the query features.

23. The computer-readable medium of claim 15, wherein the text-containing query comprises any one of a printed paper document, a hand-written paper document, an editable or non-editable electronic text document, an image file with text content, a video file with displayed text content or audio text content, or an audio file with audible text content.

24. The computer-readable medium of claim 15, wherein the feature extracting model is one of a bag-of-words model, a continuous bag-of-words model, a continuous space language model, an n-gram model, a skip-gram model, and a vector space model.

25. The computer-readable medium of claim 15, wherein the trainable classifier is one of a Naive Bayes classifier, a Support Vector Machine (SVM) classifier, a Multinomial Logistic Regression classifier, a Hidden Markov model classifier, a Neural network classifier, a k-Nearest Neighbours classifier, and a Maximum Entropy classifier.

26. A system comprising one or more processor devices and one or more storage devices storing instructions that are operable, when executed by the one or more processor devices, to cause the one or more processor devices to perform the method of claim 1.
